(19) United States
(12) Patent Application Publication
(10) Pub. No.: US 2024/0076200 A1
(43) Pub. Date: Mar. 7, 2024

(54) POSITIVE ACTIVE MATERIAL FOR RECHARGEABLE LITHIUM BATTERY, PREPARING METHOD THEREOF, AND RECHARGEABLE LITHIUM BATTERY INCLUDING THE SAME

(71) Applicant: SAMSUNG SDI CO., LTD., Yongin-si (KR)

(72) Inventors: Jungsue JANG, Yongin-si (KR); Donggyu CHANG, Yongin-si (KR); Jinyoung KIM, Yongin-si (KR); Jaeha SHIM, Yongin-si (KR); Taegeun KANG, Yongin-si (KR)

(21) Appl. No.: 18/215,713

(22) Filed: Jun. 28, 2023

(30) Foreign Application Priority Data
Aug. 19, 2022 (KR) 10-2022-0104216

(51) Int. Cl. C01G 53/00

(52) U.S. Cl. CPC C01G 53/42; C01P 2004/03; C01P 2004/61; C01P 2006/40; C01P 2006/80

(57) ABSTRACT

A positive active material includes a first positive active material including a lithium nickel-based composite oxide and including secondary particles in which a plurality of primary particles are aggregated, and a cobalt coating portion on a surface of the secondary particles; and a second positive active material including a lithium nickel-based composite oxide and including single particles and a cobalt coating portion on a surface of the single particles, wherein the surface of the single particles includes a high-concentration coating region having a cobalt content of greater than or equal to about 30 at % and a low-concentration coating region having a cobalt content of less than or equal to about 25 at % based on the total amount of nickel and cobalt, and a difference between the cobalt content in the high-concentration coating region and a cobalt content in the low-concentration coating region is about 20 at % to about 50 at %.

### CROSS-REFERENCE TO RELATED APPLICATION

This application claims priority to and the benefit of Korean Patent Application No. 10-2022-0104216, filed in the Korean Intellectual Property Office on Aug. 19, 2022, the entire content of which is hereby incorporated by reference.

### BACKGROUND

### 1. Field

Embodiments of the present disclosure relate to a positive active material for a rechargeable lithium battery, a preparing method thereof, and a rechargeable lithium battery including the same.

### 2. Description of the Related Art

Portable information devices such as cell phones, laptops, smart phones, and/or the like or electric vehicles have used rechargeable lithium batteries having high energy densities and easy portability as driving power sources. Recently, research has been actively conducted into using rechargeable lithium batteries with high energy densities as driving power sources or power storage power sources for hybrid or electric vehicles.

Various positive active materials have been investigated in order to apply rechargeable lithium batteries to the aforementioned uses. Among them, lithium nickel-based oxide, lithium nickel manganese cobalt composite oxide, lithium nickel cobalt aluminum composite oxide, lithium cobalt oxide, and/or the like are mainly utilized as a positive active material. However, these positive active materials may suffer from structural collapses or cracks during repeated charges and discharges, and thus problems of a deteriorating long-term life cycle of the rechargeable lithium battery and increasing resistance may arise, thus resulting in the rechargeable battery not exhibiting satisfactory capacity characteristics. Accordingly, development of a novel positive active material securing long-term life cycle characteristics as well as realizing high capacity and high energy density is desired (or required).

### SUMMARY

Aspects of one or more embodiments of the present disclosure are directed toward a positive active material for a rechargeable lithium battery with improved initial charge/discharge efficiency, life cycle characteristics, and safety while realizing a high capacity, a method for preparing the same, and a rechargeable lithium battery including the same.

Additional aspects will be set forth in part in the description which follows and, in part, will be apparent from the description, or may be learned by practice of the presented embodiments of the disclosure.

In one or more embodiments of the present disclosure, a positive active material for a rechargeable lithium battery includes a first positive active material including a lithium nickel-based composite oxide and including secondary particles in which a plurality of primary particles are aggregated and a cobalt coating portion on a surface of the secondary particles; and a second positive active material including a lithium nickel-based composite oxide and including single particles and a cobalt coating portion on a surface of the single particles, wherein the surface of the single particles of the second positive active material includes a high-concentration coating region having a cobalt content (e.g., amount) of greater than or equal to about 30 at % and a low-concentration coating region having a cobalt content (e.g., amount) of less than or equal to about 25 at % based on the total amount of nickel and cobalt on the surface of the single particles, and a difference between the cobalt content (e.g., amount) in the high-concentration coating region and the cobalt content (e.g., amount) in the low-concentration coating region is about 20 at % to about 50 at %.

In one or more embodiments of the present disclosure, a method of preparing a positive active material for a rechargeable lithium battery includes mixing a first nickel-based hydroxide and a lithium raw material and performing a first heat treatment to prepare a first nickel-based oxide in a form of secondary particles in which a plurality of primary particles are aggregated; mixing a second nickel-based hydroxide and a lithium raw material and performing a second heat treatment to prepare a second nickel-based oxide in a form of single particles; and mixing the first nickel-based oxide, the second nickel-based oxide, and a cobalt raw material and performing a third heat treatment to obtain the aforementioned positive active material.

In one or more embodiments of the present disclosure, a rechargeable lithium battery includes a positive electrode including the positive active material, a negative electrode, and an electrolyte.

The positive active material for a rechargeable lithium battery prepared according to one or more embodiments of the present disclosure and the rechargeable lithium battery including the same may exhibit excellent or suitable charge/discharge efficiency, life cycle characteristics, and safety while realizing high capacity and high energy density.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a schematic perspective view illustrating a rechargeable lithium battery according to one or more embodiments of the present disclosure.

FIGS. 2-4 are scanning electron microscope-energy dispersive X-ray spectroscopy (SEM-EDS) images of the second positive active material of Example 1.

FIGS. 5-7 are SEM-EDS images of the second positive active material of Comparative Example 1.

FIGS. 8-10 are SEM-EDS images of the fracture surface of the second positive active material of Example 1.

FIGS. 11-13 are SEM-EDS images of the fracture surface of the second positive active material of Comparative Example 1.

FIGS. 14 and 15 are SEM-EDS images of the second positive active material of Example 1.

FIG. 16 is a SEM-EDS image of the second positive active material of Comparative Example 1.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The terminology used herein is for the purpose of describing particular embodiments only and is not intended to limit the present disclosure. As used herein, the singular forms “a,” “an” and “the” are intended to include the plural forms as well, unless the context clearly indicates otherwise.

As used herein, “a combination thereof” refers to a mixture, a laminate, a composite, a copolymer, an alloy, a blend, a reaction product, and/or the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout, and duplicative descriptions thereof may not be provided the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

In addition, “layer” herein includes not only a shape formed on the whole surface when viewed from a plan view, but also a shape formed on a partial surface.

In the present disclosure, when particles are spherical, “diameter” indicates a particle diameter or an average particle diameter, and when the particles are non-spherical, the “diameter” indicates a major axis length or an average major axis length. The diameter (or size) of the particles may be measured utilizing a scanning electron microscope, a transmission electron microscope, or a particle size analyzer. It is also possible to obtain an average particle diameter value by measuring using a dynamic light scattering method, performing data analysis, counting the number of particles for each particle size range, and calculating from this. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

Herein, “or” is not to be construed as an exclusive meaning, for example, “A or B” is construed to include A, B, A+B, and/or the like. As used herein, the term “and/or” includes any and all combinations of one or more of the associated listed items. As used herein, “/” may be interpreted as “and”, or as “or” depending on the context.

Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

### Positive Active Material

In one or more embodiments, a positive active material for a rechargeable lithium battery includes a first positive active material including a lithium nickel-based composite oxide and including secondary particles in which a plurality of primary particles are aggregated and a cobalt coating portion on a surface of the secondary particles; and a second positive active material including a lithium nickel-based composite oxide and including single particles and a cobalt coating portion on a surface of the single particles. Herein, on the surface of the single particles of the second positive active material, there are a high-concentration coating region having a cobalt content (e.g., amount) of greater than or equal to about 30 at % and a low-concentration coating region having a cobalt content (e.g., amount) of less than or equal to about 25 at % based on the total amount of nickel and cobalt, and a difference between a cobalt content (e.g., amount) based on the total amount of nickel and cobalt in the high-concentration coating region and a cobalt content (e.g., amount) based on the total amount of nickel and cobalt in the low-concentration coating region is about 20 at % to about 50 at %. Such a positive active material may realize high capacity and high energy density, and increase the efficiency of the second positive active material in a form of single particles, thereby improving overall initial charge and discharge efficiency, life cycle characteristics, and battery safety.

### First Positive Active Material

The first positive active material has a polycrystal form, and includes secondary particles formed by aggregation of at least two or more primary particles.

The first positive active material according to one or more embodiments includes a cobalt coating portion on the surface of the secondary particles. The cobalt coating portion may be disposed on the whole or at least a portion of the surface of the secondary particle. The first positive active material is coated with cobalt and thus effectively suppresses or reduces structural collapse resulting from repetitive charges and discharges, and accordingly, life cycle characteristics at room temperature and high temperatures may be improved.

The cobalt coating portion includes a cobalt-containing compound. The cobalt-containing compound may, for example, include cobalt oxide, cobalt hydroxide, cobalt carbonate, a compound thereof, a mixture thereof, and/or the like, which may further include lithium, nickel, and/or the like. For example, the cobalt-containing compound may be lithium cobalt oxide and/or the like.

A content (e.g., amount) of the cobalt coating portion in the first positive active material may be about 0.01 mol % to about 7 mol %, for example, about 0.01 mol % to about 6 mol %, about 0.1 mol % to about 5 mol %, or about 0.5 mol % to about 3 mol % based on 100 mol % of the total metals excluding lithium in the first positive active material, and may also be about 0.01 at % to about 7 at %, about 0.1 at % to about 5 at %, or about 0.5 at % to about 3 at % based on 100 at % of the total metals excluding lithium in the first positive active material. In this case, the rechargeable lithium battery including the first positive active material may implement excellent or suitable life cycle characteristics at room temperature and high temperatures.

In the first positive active material, a thickness of the cobalt coating portion varies depending on the firing temperature during coating, and cobalt may penetrate into the active material and be coated and/or doped according to the firing temperature. Accordingly, the thickness of the cobalt coating portion may be, for example, about 1 nm to about 2 μm, about 1 nm to about 1.5 μm, about 1 nm to about 1 μm, about 1 nm to about 900 nm, about 1 nm to about 700 nm, about 1 nm to about 500 nm, about 1 nm to about 300 nm, about 5 nm to about 100 nm, or about 5 nm to about 50 nm. In this case, the rechargeable lithium battery including the first positive active material may exhibit excellent or suitable life cycle characteristics at room temperature and high temperatures. Herein, the thickness of the cobalt coating portion may be measured through an electron microscope image of the active material.

An average particle diameter (D50) of the first positive active material, that is, the average particle diameter of the secondary particles may be about 7 μm to about 25 μm. For example, it may be about 9 μm to about 25 μm, about 15 μm to about 25 μm, or about 10 μm to about 20 μm. The average particle diameter of the secondary particles of the first positive active material may be the same as or greater than the average particle diameter of the single-particle second positive active material, which will be described later. The positive active material according to one or more embodiments may be in the form of a mixture of the first positive active material, which is polycrystalline and large particles, and the second positive active material, which is single particles and small particles, thereby improving a mixture density, and providing high capacity and high energy density. Herein, the average particle diameter of the first positive active material may be obtained by randomly selecting 30 secondary particle-type or kind active materials from the electron microscope image of the positive active material to measure a particle diameter, and taking the particle diameter (D50) of the particles having a cumulative volume of 50 volume % in the particle size distribution as the average particle diameter.

The first positive active material is a nickel-based positive active material, and includes a lithium nickel-based composite oxide (or a first nickel-based oxide). A content (e.g., amount) of nickel in the lithium nickel-based composite oxide may be greater than or equal to about 30 mol %, for example, greater than or equal to about 40 mol %, greater than or equal to about 50 mol %, greater than or equal to about 60 mol %, greater than or equal to about 70 mol %, greater than or equal to about 80 mol %, greater than or equal to about 90 mol %, and less than or equal to about 99.9 mol %, or less than or equal to about 99 mol % based on the total amount of elements excluding lithium and oxygen. For example, the content (e.g., amount) of nickel in the lithium nickel-based composite oxide may be higher than that of each of the other elements such as cobalt, manganese, and aluminum. When the nickel content (e.g., amount) satisfies the above range, the positive active material may exhibit excellent or suitable battery performance while realizing a high capacity.

The first positive active material may specifically include a lithium nickel-based composite oxide represented by Chemical Formula 1.

Liₐ₁Niₓ₁M¹_{y1}M²_{1-x1-y1}O₂ Chemical Formula 1

In Chemical Formula 1, 0.9≤a1≤1.8, 0.3≤x1≤1, 0≤y1≤0.7, and M¹ and M² may each independently be at least one element of (e.g., selected from) Al, B, Ba, Ca, Ce, Co, Cr, Cu, F, Fe, Mg, Mn, Mo, Nb, P, S, Si, Sr, Ti, V, W, and/or Zr.

In Chemical Formula 1, 0.4≤x1≤1 and 0≤y1≤0.6; 0.5≤x1≤1 and 0≤y1≤0.5; 0.6≤x1≤1 and 0≤y1≤0.4; 0.7≤x1≤1 and 0≤y1≤0.3; 0.8≤x1≤1 and 0≤y1≤0.2; or 0.9≤x1≤1 and 0≤y1≤0.1.

The first positive active material may include, for example, a lithium nickel-based composite oxide represented by Chemical Formula 2.

Liₐ₂Niₓ₂Co_{y2}M³_{1-x2-y2}O₂ Chemical Formula 2

In Chemical Formula 2, 0.9≤a2≤1.8, 0.3≤x2≤1, 0≤y2≤0.7, and M³ is at least one element of (e.g., selected) from Al, B, Ba, Ca, Ce, Cr, Cu, F, Fe, Mg, Mn, Mo, Nb, P, S, Si, Sr, Ti, V, W, and/or Zr.

In Chemical Formula 2, 0.3≤x2≤0.99 and 0.01≤y2≤0.7; 0.4≤x2≤0.99 and 0.01≤y2≤0.6; 0.5≤x2≤0.99 and 0.01≤y2≤0.5; 0.6≤x2≤0.99 and 0.01≤y2≤0.4; 0.7≤x2≤0.99 and 0.01≤y2≤0.3; 0.8≤x2≤0.99 and 0.01≤y2≤0.2; or 0.9≤x2≤0.99 and 0.01≤y2≤0.1.

The first positive active material may include, for example, a compound of Chemical Formula 3.

Liₐ₃Niₓ₃Co_{y3}M⁴_{z3}M⁵_{1-x3-y3-z3}O₂ Chemical Formula 3

In Chemical Formula 3, 0.9≤a3≤1.8, 0.3≤x3≤0.98, 0.01≤y3≤0.69, 0.01≤z3≤0.69, M⁴ is at least one element of (e.g., selected from) Al, and/or Mn, and M⁵ is at least one element of (e.g., selected from) B, Ba, Ca, Ce, Cr, Cu, F, Fe, Mg, Mo, Nb, P, S, Si, Sr, Ti, V, W, and/or Zr.

In Chemical Formula 3 0.4≤x3≤0.98, 0.01≤y3≤0.59, and 0.01≤z3≤0.59; 0.5≤x3≤0.98, 0.01≤y3≤0.49, and 0.01≤z3≤0.49; 0.6≤x3≤0.98, 0.01≤y3≤0.39, and 0.01≤z3≤0.39; 0.7≤x3≤0.98, 0.01≤y3≤0.29, and 0.01≤z3≤0.29; 0.8≤x3≤0.98, 0.01≤y3≤0.19, and 0.01≤z3≤0.19; or 0.9≤x3≤0.98, 0.01≤y3≤0.09, and 0.01≤z3≤0.09.

### Second Positive Active Material

The second positive active material is in the form of a single particle, exists alone without a grain boundary within the particle, is composed of one particle, and may be single particle or have a monolith structure or a one body structure, in which particles are not aggregated with each other but exist as an independent phase in terms of morphology, or a non-aggregated particle, and may be expressed as a single particle (one body particle, single grain), for example, as a monocrystal (single crystal). The positive active material according to one or more embodiments may include the second positive active material in a form of single particles, thereby exhibiting improved life cycle characteristics while implementing high capacity and high energy density.

The second positive active material has no particular limit to a shape but may have one or more suitable shapes such as a polyhedron, a spherical, an oval, a plate, a rod, an irregular shape, and/or the like. The single-particle second positive active material according to one or more embodiments may have a polyhedral structure having two or more surfaces.

The second positive active material according to one or more embodiments includes a cobalt coating portion on the surface of the single particle. Because the second positive active material is coated with cobalt, collapse of the structure due to repeated charging and discharging is effectively suppressed or reduced, so that life cycle characteristics at room temperature and high temperature can be improved.

The cobalt coating portion includes a cobalt-containing compound. The cobalt-containing compound may be, for example, cobalt oxide, cobalt hydroxide, cobalt carbonate, a compound thereof, or a mixture thereof, and these may further include lithium and/or nickel. For example, the cobalt-containing compound may be lithium cobalt oxide and/or the like.

In one or more embodiments, instead of uniformly distributing the cobalt-containing compound over the entire surface of the single particle of the second positive active material, a high content (e.g., amount) of the cobalt-containing compound is coated on a portion of the surface of the single particle, thereby improving battery performance and increasing safety. For example, on the surface of the single particle, there are a high-concentration coating region having a cobalt content (e.g., amount) of greater than or equal to about 30 at % and a low-concentration coating region having a cobalt content (e.g., amount) of less than or equal to about 25 at % based on the total amount of nickel and cobalt, and a difference between the cobalt content (e.g., amount) based on the total amount of nickel and cobalt in the high-concentration coating region and the cobalt content (e.g., amount) based on the total amount of nickel and cobalt in the low-concentration coating region is about 20 at % to about 50 at %. When the second positive active material is applied, the initial charge/discharge efficiency and life cycle characteristics of the battery may be improved compared to a case in which a cobalt-containing compound is uniformly coated on the entire surface of the single particle.

The high-concentration coating region is defined as a region in which the cobalt content (e.g., amount) based on the total amount of nickel and cobalt on the surface of the single particle is greater than or equal to about 30 at %, and for example, the cobalt content (e.g., amount) may be about 30 at % to about 70 at %, about 30 at % to about 60 at %, or about 40 at % to about 70 at %. The high-concentration coating region may occupy about 30% to about 80%, for example, about 30% to about 70%, or about 40% to about 80% of the total area of the single particle surface (e.g., where the above percentages are average percentages calculated from among the single particles of the second positive active material).

On the surface of the single particles of the second positive active material, there is also a low-concentration coating region in which the cobalt content (e.g., amount) is less than or equal to about 25 at % based on the total amount of nickel and cobalt on the surface of the single particles, and the low-concentration coating region may occupy greater than or equal to about 10% of the total area of the surface of the single particle (e.g., where the above percentages may be average percentages calculated from among the single particles of the second positive active material).

The low-concentration coating region is defined as a region in which the cobalt content (e.g., amount) based on the total amount of nickel and cobalt on the surface of the single particle is less than or equal to about 25 at %, for example, about 0 at % to about 25 at %, about 5 at % to about 25 at %, or about 10 at % to about 20 at %. The low-concentration coating region occupies greater than or equal to about 10% of the total area of the single particle surface, and may occupy, for example, about 10% to about 70%, about 10% to about 50%, about 10% to about 30%, or about 10% to about 20% (e.g., where the above percentages may be average percentages calculated from among the single particles of the second positive active material). As such, when the high-concentration coating region and the low-concentration coating region on the surface of the single particle each exist in the above area ranges, the initial charging and discharging efficiency and life cycle characteristics may be improved compared to the case in which the cobalt-containing compound is evenly coated or the cobalt-containing compound is not coated.

The difference between the cobalt content (e.g., amount) based on the total amount of nickel and cobalt in the high-concentration coating region and the cobalt content (e.g., amount) based on the total amount of nickel and cobalt in the low-concentration coating region may be about 20 at % to about 50 at %, for example about 20 at % to about 45 at %, or about 25 at % to about 40 at %. When the difference in the cobalt content (e.g., amount) in the high-concentration coating region and the low-concentration coating region is as described above, the efficiency of the single-particle second positive active material may be increased.

The second positive active material according to one or more embodiments is distinguished from the positive active material having a high cobalt content (e.g., amount) of greater than or equal to about 30 at % based on the total amount of nickel and cobalt in the lithium nickel-based composite oxide itself inside the active material. The second positive active material has a high cobalt content (e.g., amount) on the surface, and it corresponds to the positive active material in which the high-concentration coating region has a cobalt content (e.g., amount) of greater than or equal to about 30 at % formed on a portion of the surface by coating of a cobalt-containing compound. For example, the cobalt content (e.g., amount) based on the total amount of nickel and cobalt inside the single particle of the second positive active material may be about 0 at % to about 15 at %, for example, about 0.1 at % to about 10 at %, or about 0.1 at % to about 6 at %, and may also be about 0 mol % to about 15 mol %, about 0.1 mol % to about 10 mol %, or about 0.1 mol % to about 6 mol %. The difference between the cobalt content (e.g., amount) based on the total amount of nickel and cobalt in the high-concentration coating region on the surface of the second positive active material and the cobalt content (e.g., amount) based on the total amount of nickel and cobalt inside the second positive active material may be greater than or equal to about 20 at %, greater than or equal to about 30 at %, or greater than or equal to about 40 at %. This second positive active material may realize high capacity and high life cycle characteristics.

In one or more embodiments, an average value of the cobalt content (e.g., amount) based on the total amount of nickel and cobalt on the surface of the single particle of the second positive active material may be about 20 at % to about 60 at %, for example, about 20 at % to about 50 at %, or about 25 at % to about 45 at %. The average value may refer to a value obtained by measuring the concentrations of about 5 to 10 portions on the surface of a single particle, irrespective of the high-concentration region and the low-concentration region, and obtaining an arithmetic average of these values.

In the second positive active material, the difference between the average value of the cobalt content (e.g., amount) based on the total amount of nickel and cobalt on the surface of the single particle and the cobalt content (e.g., amount) based on the total amount of nickel and cobalt inside the single particle may be about 10 at % to about 60 at %, for example, about 20 at % to about 50 at %, or about 25 at % to about 45 at %. In these cases, the second positive active material may exhibit high efficiency and life cycle characteristics while realizing a high capacity.

In one or more embodiments, the method of measuring the cobalt content (e.g., amount) based on the total amount of nickel and cobalt on the surface of the positive active material may include performing a scanning electron microscope-energy dispersive X-ray spectroscopy (SEM-EDS) on the surface of the positive active material, and calculating the ratio of the cobalt content (e.g., amount) to the sum of nickel and cobalt contents through quantitative analysis. The cobalt content (e.g., amount) based on the total amount of nickel and cobalt in the positive active material may be measured through SEM-EDS analysis of the fracture surface of the positive active material. The method for measuring the cobalt content (e.g., amount) may be inductively coupled plasma-mass spectrometry (ICP-MS) or inductively coupled plasma optical emission spectroscopy (ICP-OES), etc., in addition to SEM-EDS.

The second positive active material includes a lithium nickel-based composite oxide (or a second nickel-based oxide) as a nickel-based active material. The nickel content (e.g., amount) in the lithium nickel-based composite oxide may be greater than or equal to about 60 mol %, for example, greater than or equal to about 70 mol %, greater than or equal to about 80 mol %, or greater than or equal to about 90 mol %, and less than or equal to about 99.9 mol %, or less than or equal to about 99 mol % based on the total amount of elements excluding lithium and oxygen. For example, the nickel content (e.g., amount) in the lithium nickel composite oxide may be higher than each content (e.g., amount) of other transition metals such as cobalt, manganese, and aluminum. When the nickel content (e.g., amount) satisfies the above ranges, the positive active material may exhibit excellent or suitable battery performance while realizing a high capacity.

The second positive active material may include, for example, a lithium nickel-based composite oxide represented by Chemical Formula 11.

Liₐ₁₁Niₓ₁₁Co_{y11}M¹_{1-x11-y11}O₂ Chemical Formula 11

In Chemical Formula 11, 0.9≤a11≤1.8, 0.6≤x11≤1, and 0≤y11≤0.15, and M¹¹ is at least one element of (e.g., selected from) Al, B, Ba, Ca, Ce, Cr, Cu, F, Fe, Mg, Mn, Mo, Nb, P, S, Si, Sr, Ti, V, W, and/or Zr.

In Chemical Formula 11, x11 representing a Ni content (e.g., amount) may be, for example, 0.7≤x11≤1, 0.8≤x11≤1, or 0.9≤x11≤1. When the nickel content (e.g., amount) is greater than or equal to about 90 mol %, a very high capacity may be realized, and problems in which the structure collapses, cracks, or side reactions occur during life cycle may be suppressed or reduced due to the cobalt coating portion according to one or more embodiments.

An average particle diameter of the second positive active material, for example, the average particle diameter of the single particles may be about 0.05 μm to about 7 μm, for example, about 0.1 μm to about 6 μm, or about 0.5 μm to about 5 μm, or about 1 μm to about 7 μm. The particle diameter of the second positive active material may be the same as or smaller than that of the first positive active material, and thus the density of the positive active material may be further increased. Herein, the average particle diameter of the second positive active material may be obtained by randomly selecting 30 single-particle active materials from the electron microscope image of the positive active material to measure a particle diameter, and taking the particle diameter (D50) of the particles having a cumulative volume of 50 volume % in the particle size distribution as the average particle diameter.

The BET specific surface area of the entire positive active material including the first positive active material and the second positive active material may be about 0.2 m²/g to about 0.6 m²/g, for example, about 0.3 m²/g to about 0.5 m²/g, or about 0.3 m²/g to about 0.4 m²/g. In these cases, the positive active material may realize excellent or suitable charge/discharge efficiency and life cycle characteristics. The BET specific surface area may be measured by, for example, a nitrogen gas adsorption method utilizing a specific surface area measuring device HM model-1208 manufactured by MOUNTECH. For example, about 0.3 g of the positive active material sample is heated in a nitrogen atmosphere at 300° C. in a preprocessor for 1 hour, then additionally pretreated at 300° C. in a specific surface area measuring device for 15 minutes, cooled to the temperature of liquid nitrogen, and saturated and adsorbed with a gas of 30% nitrogen and 70% helium. Thereafter, the amount of desorbed gas is measured by heating to room temperature, and the specific surface area may be calculated from the obtained result by a normal BET method.

In the positive active material according to one or more embodiments, the first positive active material may be included in an amount of about 50 wt % to about 90 wt %, and the second positive active material may be included in an amount of about 10 wt % to about 50 wt % based on the total amount of the first positive active material and the second positive active material. The first positive active material may be for example included in an amount of about 60 wt % to about 90 wt %, or about 70 wt % to about 90 wt % and the second positive active material may be for example included in an amount of about 10 wt % to about 40 wt %, or about 10 wt % to about 30 wt %. When the content (e.g., amount) ratio of the first positive active material and the second positive active material is as described above, the positive active material including the same may realize high capacity, improve a mixture density, and exhibit high energy density.

### Method of Preparing Positive Active Material

In one or more embodiments, a method of preparing a positive active material for a rechargeable lithium battery includes mixing a first nickel-based hydroxide and a lithium raw material and performing a first heat treatment to prepare a first nickel-based oxide in a form of secondary particles in which a plurality of primary particles are aggregated, mixing a second nickel-based hydroxide and a lithium raw material and performing a second heat treatment to prepare a second nickel-based oxide in a form of single particles, and mixing the first nickel-based oxide, the second nickel-based oxide, and a cobalt raw material and performing a third heat treatment to obtain the final positive active material including the aforementioned first positive active material and second positive active material.

The first positive active material may be a material in which a cobalt-containing compound is coated on the surface of the first nickel-based oxide, and the second positive active material may be a material in which the surface of the second nickel-based oxide is coated with a cobalt-containing compound.

In one or more embodiments, the first positive active material and the second positive active material may be prepared by not individually coating the first nickel-based oxide and the second nickel-based oxide but concurrently (e.g., simultaneously) coating them after first mixing them. According to this, instead of uniformly coating the surface of the single particle, which is the second positive active material, the cobalt-containing compound is coated on only a portion of the surface with a high content (e.g., amount), and efficiency of the single particle is increased, so that the initial charge/discharge efficiency and life cycle characteristics of the rechargeable lithium battery including the same may be improved.

The first nickel-based hydroxide and the second nickel-based hydroxide are precursors of the positive active material and may each independently be a nickel hydroxide, a nickel-based composite hydroxide containing an element other than nickel, or a nickel-transition elements composite hydroxide containing a transition metal other than nickel.

For example, the first nickel-based hydroxide may be represented by Chemical Formula 21.

Niₓ₂₁M²¹_{y21}M²_{21-x21-y21}(OH)₂ Chemical Formula 21

In Chemical Formula 21, 0.3≤x21≤1, 0≤y21≤0.7, and M²¹ and M²² may each independently be at least one element of (e.g., selected from) Al, B, Ba, Ca, Ce, Co, Cr, Cu, F, Fe, Mg, Mn, Mo, Nb, P, S, Si, Sr, Ti, V, W, and/or Zr.

The second nickel-based hydroxide may be represented by Chemical Formula 31.

Niₓ₃₁CO_{y31}M³¹_{1-x31-y31}(OH)₂ Chemical Formula 31

In Chemical Formula 31, 0.6≤x31≤1, and 0≤y31≤0.15, and M³¹ is at least one element of (e.g., selected from) Al, B, Ba, Ca, Ce, Cr, Cu, F, Fe, Mg, Mn, Mo, Nb, P, S, Si, Sr, Ti, V, W, and/or Zr.

The particle diameters of the first nickel hydroxide and the second nickel hydroxide may each independently be about 1 μm to about 30 μm, for example, about 1 μm to about 25 μm, about 1 μm to about 20 μm, or about 5 μm to about 20 μm. The particle size of the nickel-based hydroxide is measured by a particle size analyzer utilizing laser diffraction, and may refer to a diameter (D50) of particles having a cumulative volume of 50 volume % in the particle size distribution.

The lithium raw material is a lithium source of the positive active material and may include, for example, Li₂CO₃, LiOH, a hydrate thereof, or a combination thereof.

When the first nickel-based hydroxide is mixed with the lithium raw material, a ratio of a mole number of lithium in the lithium raw material relative to a mole number of metals included in the first nickel-based hydroxide, for example, may be greater than or equal to about 0.8, greater than or equal to about 0.85, greater than or equal to about 0.9, greater than or equal to about 0.95, or greater than or equal to about 1.0 and less than or equal to about 1.8, less than or equal to about 1.5, less than or equal to about 1.2, less than or equal to about 1.1, or less than or equal to about 1.05.

The first heat-treatment may be performed under an oxidizing gas atmosphere, for example, under an oxygen atmosphere or an air atmosphere. In one or more embodiments, the first heat-treatment may be performed at about 600° C. to about 900° C. or about 600° C. to about 800° C., for example, for about 5 hours to about 20 hours, for example 5 hours to 15 hours. The first nickel-based oxide obtained through the first heat treatment may be referred to as a first lithium nickel-based oxide or a first nickel-based composite oxide.

When the second nickel-based hydroxide is mixed with the lithium raw material, a ratio of a mole number of lithium in the lithium raw material relative to a mole number of a metal included in the second nickel-based hydroxide may be, for example, greater than or equal to about 0.8, greater than or equal to about 0.85, greater than or equal to about 0.9, greater than or equal to about 0.95, or greater than or equal to about 1.0 and less than or equal to about 1.8, less than or equal to about 1.5, less than or equal to about 1.2, less than or equal to about 1.1, or less than or equal to about 1.05.

The second heat-treatment also may be performed under the oxidizing gas atmosphere, for example, under the oxygen atmosphere or under the air atmosphere. In one or more embodiments, the second heat-treatment may be performed, for example, at about 800° C. to about 1100° C., or about 900° C. to about 1000° C., for example, for about 5 hours to about 20 hours or about 5 hours to about 15 hours. The second nickel-based oxide obtained through the second heat treatment may be referred to as a second lithium nickel-based oxide or a second nickel-based composite oxide.

The second nickel-based oxide is in a form of single particles, and the single-particle form may be obtained by controlling the conditions such as temperature and time of the second heat treatment or may be obtained through one or more suitable conditions when synthesizing the second nickel-based hydroxide by the co-precipitation method.

The method of preparing the positive active material for a rechargeable lithium battery may further include pulverizing the product obtained by mixing the second nickel-based hydroxide and the lithium raw material and performing the second heat treatment, through which a second nickel-based oxide of single particles may also be obtained. The pulverization may be performed by utilizing one or more suitable pulverizing devices such as a jet mill and/or the like. Herein, the pulverizing of the obtained product is a process of obtaining a single-particle active material, which is distinguished from the crushing of a general active material.

When the first nickel-based oxide is mixed with the second nickel-based oxide, the first nickel-based oxide and the second nickel-based oxide may have a weight ratio of about 9:1 to about 5:5, for example, about 9:1 to about 6:4, or about 8:2 to about 7:3. When the first nickel-based oxide and the second nickel-based oxide are mixed within the aforementioned range, the obtained positive active material may exhibit high-capacity high energy density and high electrode plate density.

Then, the cobalt coating is performed by mixing the first nickel-based oxide, the second nickel-based oxide, and the cobalt raw material and performing a third heat treatment. The cobalt raw material may be, for example, cobalt hydroxide, cobalt carbonate, cobalt sulfate, cobalt oxide, cobalt nitrate, and/or the like. When the content (e.g., amount) of the metal other than lithium in the total positive active material is 100 parts by mole, it may be mixed so that an amount of cobalt contained in the cobalt raw material may be about 0.01 parts by mole to about 7 parts by mole, about 0.01 parts by mole to about 5 parts by mole, or about 0.1 parts by mole to about 4 parts by mole.

The cobalt coating may be performed either dry or wet. For example, after mixing the first nickel-based oxide, the second nickel-based oxide, and the cobalt raw material without a solvent, the third heat treatment is performed for the dry coating. Or, the first nickel-based oxide and the second nickel-based oxide are added to a solvent such as distilled water and/or the like and then, washed, while mixed, and then, the cobalt raw material is added dropwise thereto to perform the wet coating and then, followed by the third heat treatment.

In one or more embodiments, when the first nickel-based oxide, the second nickel-based oxide, and the cobalt raw material are mixed, a lithium raw material is mixed therewith together. The lithium raw material may be, for example Li₂CO₃, LiOH, a hydrate thereof, or a combination thereof. The lithium raw material may be mixed in an amount of about 1 part by mole to about 4 parts by mole based on about 1 part by mole of the cobalt raw material mixed therewith together, for example, in an amount of about 1.5 parts by mole to about 3 parts by mole. In other words, the lithium raw material may be added about 1 time to about 4 times or about 1.5 times to about 3 times as much as the cobalt raw material. Or, the lithium raw material may be mixed in an amount of about 0.01 parts by mole to about 10 parts by mole, about 0.1 parts by mole to about 8 parts by mole, or about 1 part by mole to about 6 parts by mole based on about 100 parts by mole of a total amount of metals excluding lithium in the positive active material. In this way, when the lithium raw material is added together during the cobalt coating, a stable cobalt coating portion may be formed on the positive active material surface, wherein the cobalt coating portion may be formed to have about 30% to about 80% of a high-concentration coating region on the single particle surface according to one or more embodiments. Accordingly, initial charge and discharge efficiency and life cycle characteristics of a rechargeable lithium battery may be improved.

In one or more embodiments, when the wet cobalt coating is adopted, the first nickel-based oxide, the second nickel-based oxide, and the cobalt raw material are mixed with a pH controlling agent such as sodium hydroxide and/or the like. The pH controlling agent may be added in an amount of about 0.5 parts by mole to about 5 parts by mole based on about 1 part by mole of the cobalt raw material. In this way, the pH controlling agent and/or the like are utilized to effectively form the cobalt coating portion according to one or more embodiments.

The third heat treatment may be performed under an oxidizing gas atmosphere such as oxygen or air atmosphere and/or the like. In some embodiments, the third heat-treatment may be performed, for example, at about 650° C. to about 900° C. or about 650° C. to about 800° C. The third heat-treatment may be performed during variable time depending on a heat-treatment temperature and/or the like, for example, for about 5 hours to about 30 hours or about 10 hours to about 24 hours.

Thereafter, by terminating the heat treatment and cooling to room temperature, the aforementioned positive active material for a rechargeable lithium battery according to one or more embodiments may be prepared. The prepared positive active material is in a state in which a first positive active material including secondary particles formed by aggregation of primary particles and a second positive active material in a form of single particles are mixed. On the surface of the single particles of the second positive active material, the second positive active material includes a high-concentration coating region having a cobalt content (e.g., amount) of greater than or equal to about 30 at % and a low-concentration coating region having a cobalt content (e.g., amount) of less than or equal to about 25 at % based on the total amount of nickel and cobalt, and a difference between a cobalt content (e.g., amount) based on the total amount of nickel and cobalt in the high-concentration coating region and a cobalt content (e.g., amount) based on the total amount of nickel and cobalt in the low-concentration coating region is about 20 at % to about 50 at %.

### Positive Electrode

A positive electrode for a rechargeable lithium battery may include a current collector and a positive active material layer on the current collector. The positive active material layer may include a positive active material, and may further include a binder and/or a conductive material.

The binder improves binding properties of positive active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

The content (e.g., amount) of the binder in the positive active material layer may be about 1 wt % to about 5 wt % based on the total weight of the positive active material layer.

The conductive material is included to provide electrode conductivity and any electrically conductive material may be utilized as a conductive material unless it causes a chemical change in a battery. Examples of the conductive material include a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum silver, and/or the like; a conductive polymer such as a polyphenylene derivative; or a mixture thereof.

The content (e.g., amount) of the conductive material in the positive active material layer may be about 1 wt % to about 5 wt % based on the total weight of the positive active material layer.

An aluminum foil may be utilized as the positive electrode current collector, but the present disclosure is not limited thereto.

### Negative Electrode

A negative electrode for a rechargeable lithium battery includes a current collector and a negative active material layer on the current collector. The negative active material layer may include a negative active material, and may further include a binder and/or a conductive material.

The negative active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include, for example, crystalline carbon, amorphous carbon, or a combination thereof as a carbon-based negative active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal including (e.g., selected from) Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative active material or a Sn-based negative active material. The Si-based negative active material may include silicon, a silicon-carbon composite, SiOₓ (0<x<2), a Si-Q alloy (wherein Q is an element including (e.g., selected from) an alkali metal, an alkaline-earth metal, a Group 13 element, a Group 14 element, a Group 15 element, a Group 16 element, a transition metal, a rare earth element, and/or a combination thereof, but not Si) and the Sn-based negative active material may include Sn, SnO₂, a Sn—R alloy (wherein R is an element including (e.g., selected from) an alkali metal, an alkaline-earth metal, a Group 13 element, a Group 14 element, a Group 15 element, a Group 16 element, a transition metal, a rare earth element, and/or a combination thereof, but not Sn). At least one of these materials may be mixed with SiO₂. The elements Q and R may be (e.g., may be selected from) Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and/or a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In one or more embodiments, the content (e.g., amount) of silicon may be about 10 wt % to about 50 wt % based on the total weight of the silicon-carbon composite. In one or more embodiments, the content (e.g., amount) of the crystalline carbon may be about 10 wt % to about 70 wt % based on the total weight of the silicon-carbon composite, and the content (e.g., amount) of the amorphous carbon may be about 20 wt % to about 40 wt % based on the total weight of the silicon-carbon composite. In one or more embodiments, a thickness of the amorphous carbon coating layer may be about 5 nm to about 100 nm. An average particle diameter (D50) of the silicon particles may be about 10 nm to about 20 μm. In one or more embodiments, the average particle diameter (D50) of the silicon particles may be about 10 nm to about 200 nm. The silicon particles may exist in an oxidized form, and in this case, an atomic content (e.g., amount) ratio of Si:O in the silicon particles indicating a degree of oxidation may be about 99:1 to about 33:67. The silicon particles may be SiOₓ particles, and in this case, the range of x in SiOₓ may be greater than about 0 and less than about 2. In the present specification, unless otherwise defined, an average particle diameter (D50) indicates a particle diameter of particles where a cumulative volume is about 50 volume % in a particle size distribution.

The Si-based negative active material or Sn-based negative active material may be mixed with the carbon-based negative active material. When the Si-based negative active material or Sn-based negative active material and the carbon-based negative active material are mixed and utilized, the mixing ratio may be a weight ratio of about 1:99 to about 90:10.

In the negative active material layer, the negative active material may be included in an amount of about 95 wt % to about 99 wt % based on the total weight of the negative active material layer.

In one or more embodiments, the negative active material layer further includes a binder, and may optionally further include a conductive material. The content (e.g., amount) of the binder in the negative active material layer may be about 1 wt % to about 5 wt % based on the total weight of the negative active material layer. In one or more embodiments, when the conductive material is further included, the negative active material layer may include about 90 wt % to about 98 wt % of the negative active material, about 1 wt % to about 5 wt % of the binder, and about 1 wt % to about 5 wt % of the conductive material.

The binder serves to well adhere the negative active material particles to each other and also to adhere the negative active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may include (e.g., may be selected from) a styrene-butadiene rubber, an acrylated styrene-butadiene rubber, an acrylonitrile-butadiene rubber, an acrylic rubber, a butyl rubber, a fluororubber, and/or a combination thereof. The polymer resin binder may include (e.g., may be selected from) polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and/or a combination thereof.

When a water-soluble binder is utilized as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and utilized. As the alkali metal, Na, K, or Li may be utilized. The amount of the thickener utilized may be about 0.1 parts by weight to about 3 parts by weight based on 100 parts by weight of the negative active material.

The conductive material is included to provide electrode conductivity and any electrically conductive material may be utilized as a conductive material unless it causes a chemical change in a battery. Examples of the conductive material include a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum silver, and/or the like; a conductive polymer such as a polyphenylene derivative; or a mixture thereof.

The negative electrode current collector may include (e.g., may be selected from) a copper foil, a nickel foil, a stainless steel foil, a titanium foil, a nickel foam, a copper foam, a polymer substrate coated with conductive metal, and/or a combination thereof.

### Rechargeable Lithium Battery

One or more embodiments of the present disclosure provide a rechargeable lithium battery including a positive electrode, a negative electrode, a separator between the positive electrode and the negative electrode, and an electrolyte.

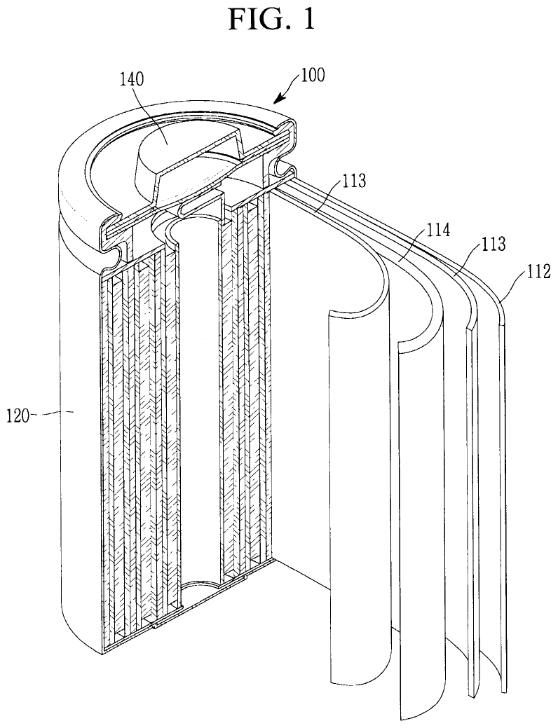

FIG. 1 is a schematic view illustrating a rechargeable lithium battery according to one or more embodiments of the present disclosure. Referring to FIG. 1, a rechargeable lithium battery 100 according to one or more embodiments includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or an aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like and the ketone-based solvent may be cyclohexanone, and/or the like. In one or more embodiments, the alcohol-based solvent may be ethyl alcohol, isopropyl alcohol, etc. and the aprotic solvent may be nitriles such as R-CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. When the organic solvent is utilized in a mixture, the mixture ratio may be controlled or selected in accordance with a desirable battery performance.

In one or more embodiments, in the case of the carbonate-based solvent, a mixture of a cyclic carbonate and a chain carbonate may be utilized. In these cases, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent in addition to the carbonate-based solvent. In such cases, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be utilized.

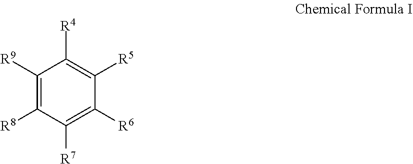

In Chemical Formula I, R⁴ to R⁹ may each independently be the same or different and may include (e.g., may be selected from) hydrogen, a halogen, a C1 to C10 alkyl group, a C1 to C10 haloalkyl group, and/or a combination thereof.

Specific examples of the aromatic hydrocarbon-based solvent may be (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte may further include vinylene carbonate or an ethylene carbonate-based compound of Chemical Formula II in order to improve the life cycle characteristics of a battery.

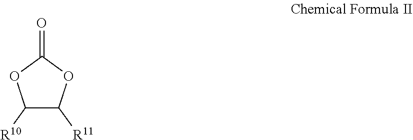

In Chemical Formula II, R¹⁰ and R¹¹ may each independently be the same or different, and may include (e.g., may be selected from) hydrogen, a halogen, a cyano group, a nitro group, and/or a fluorinated C1 to C5 alkyl group, provided that at least one of R¹⁰ and R¹¹ includes (e.g., is selected from) a halogen, a cyano group, a nitro group, and/or a fluorinated C1 to C5 alkyl group, but both of R¹⁰ and R¹¹ are not hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving life cycle characteristics may be utilized within an appropriate or suitable range.

The lithium salt dissolved in the non-aqueous organic solvent supplies lithium ions in a battery, enables a basic operation of a rechargeable lithium battery, and improves transportation of the lithium ions between positive and negative electrodes.

Examples of the lithium salt may include one or more of (e.g., one or more selected from) LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), where x and y are natural numbers, for example, integers from 1 to 20, lithium difluoro(bisoxalato) phosphate, LiCl, LiI, LiB(C₂O₄)₂ (lithium bis(oxalato) borate; LiBOB), and/or lithium difluoro(oxalato)borate (LiDFOB).

The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

The separator 113 separates a positive electrode 114 and a negative electrode 112 and provides a transporting passage for lithium ions and may be any generally-utilized separator in a lithium ion battery. In other words, it may have low resistance to ion transport and excellent or suitable impregnation for an electrolyte. For example, the separator 113 may include glass fiber, polyester, polyethylene, polypropylene, polytetrafluoroethylene, or a combination thereof, and may be in the form of a nonwoven fabric or a woven fabric. For example, in a lithium ion battery, a polyolefin-based polymer separator such as polyethylene and polypropylene may be mainly utilized. In order to ensure the heat resistance or mechanical strength, a coated separator including a ceramic component or a polymer material may be utilized. Optionally, it may have a mono-layered or multi-layered structure.

Rechargeable lithium batteries may be classified as lithium ion batteries, lithium ion polymer batteries, and lithium polymer batteries according to the presence of a separator and the kind of electrolyte utilized therein. The rechargeable lithium batteries may have a variety of shapes and sizes, and include cylindrical, prismatic, coin, or pouch-type or kind batteries, and may be thin film batteries or may be rather bulky in size. Structures and manufacturing methods for lithium ion batteries pertaining to this disclosure are well generally available in the art.

The rechargeable lithium battery according to one or more embodiments may be utilized in an electric vehicle (EV), a hybrid electric vehicle such as a plug-in hybrid electric vehicle (PHEV), and/or a portable electronic device because it implements a high capacity and has excellent or suitable storage stability, life cycle characteristics, and high rate characteristics at high temperatures.

Hereinafter, examples of the present disclosure and comparative examples are described. It is to be understood, however, that the examples are for the purpose of illustration and are not to be construed as limiting the present disclosure.

### Example 1

### 1. Preparation of First Nickel-Based Oxide in a Form of Secondary Particles

As metal raw materials, nickel sulfate (NiSO₄·6H₂O), cobalt sulfate (CoSO₄·7H₂O) and manganese sulfate (MnSO₄·H₂O) were mixed in a molar ratio of 95:4:1 and dissolved in distilled water as a solvent to prepare a mixed solution, and 10 wt % ammonia water (NH₄OH) was prepared to form a complex and 20 wt % sodium hydroxide (NaOH) was prepared as a precipitating agent.

After adding the dilute ammonia water solution to the continuous reactor, the metal raw material mixed solution was substantially continuously added, and sodium hydroxide was added to maintain the pH inside the reactor. After slowly conducting a reaction for about 80 hours, when the reaction was stabilized, a product overflown therefrom was collected and then washed and dried, obtaining a final precursor. Accordingly, a first nickel-based hydroxide (Ni_{0.95}Co_{0.04}Mn_{0.01}(OH)₂) in a form of secondary particles in which primary particles are aggregated was obtained, washed and dried.

The first nickel-based hydroxide was mixed with LiOH so that a molar ratio of lithium to the total amount of metal of the first nickel-based hydroxide was 1.04, and the mixture was subjected to a first heat treatment at about 750° C. for 15 hours in an oxygen atmosphere to obtain the first nickel-based oxide (LiNi_{0.95}Co_{0.04}Mn_{0.01}O₂). The obtained first nickel-based oxide was in a form of secondary particles in which primary particles were aggregated, and the secondary particle had an average particle diameter of about 15 μm.

### 2. Preparation of Second Nickel-Based Oxide in a Form of Single Particles

A mixed solution was prepared by dissolving nickel sulfate, cobalt sulfate, and manganese sulfate in distilled water as a solvent. In order to form a complex, 10 wt % dilute ammonia water (NH₄OH) solution and 20 wt % sodium hydroxide (NaOH) as a precipitant were prepared. Subsequently, the metal raw material mixed solution, the ammonia water, and the sodium hydroxide were each put into a reactor. Then, while stirred, a reaction proceeded for about 20 hours. Then, the slurry solution in the reactor was filtered, washed with distilled water with high purity, and dried for 24 hours, obtaining a second nickel-based hydroxide (Ni_{0.94}Co_{0.05}Mn_{0.01}(OH)₂) powder. The obtained second nickel-based hydroxide powder had an average particle diameter of about 4.0 μm and a specific surface area of about 15 m²/g, which was measured in a BET method.

The obtained second nickel-based hydroxide and LiOH were mixed to satisfy Li/(Ni+Co+Mn)=1.05 (a molar ratio) and then, put in a furnace to perform a second heat treatment at 910° C. under an oxygen atmosphere for 8 hours. Subsequently, a product obtained therefrom was pulverized for about 30 minutes and then, separated/dispersed into a plurality of second nickel-based oxides having a single-particle form. The obtained single particle-type or kind second nickel-based oxides (LiNi_{0.94}Co_{0.05}Mn_{0.01}O₂) had an average particle diameter of about 3.7 μm.

### 3. Preparation of Cobalt Coating Portion and Final Positive Active Material

The first nickel-based oxide and the second nickel-based oxide were mixed in a weight ratio of 7:3, and this mixture was washed in a weight ratio of 1:1 with water in a stirrer and dried at 150° C. Subsequently, 5 parts by mole of lithium hydroxide and 2.5 parts by mole of cobalt oxide based on 100 parts by mole of transition metals of the total nickel-based oxides were additionally mixed therewith and then, put in the furnace to perform a third heat treatment at about 710° C. under an oxygen atmosphere for 15 hours. Subsequently, the furnace was cooled down to room temperature, obtaining a final positive active material in which the first positive active material and the second positive active material were mixed.

The final positive active material was a mixture of the first positive active material in a form of secondary particles and the second positive active material in a form of single particles which were respectively coated with cobalt.

### 4. Manufacture of Positive Electrode

95 wt % of the final positive active material, 3 wt % of a polyvinylidene fluoride binder, and 2 wt % of carbon nanotube conductive material were mixed in an N-methylpyrrolidone solvent to prepare a positive active material slurry. The positive active material slurry was applied to an aluminum current collector, dried, and then compressed to manufacture a positive electrode.

### 5. Manufacture of Coin Half-Cell

A coin half-cell was manufactured by disposing a separator having a polyethylene polypropylene multilayer structure disposed between the manufactured positive electrode and lithium metal counter electrode, and injecting an electrolyte in which 1.0 M LiPF₆ lithium salt was added to a solvent in which ethylene carbonate and diethyl carbonate were mixed in a volume ratio of 50:50.

### Comparative Example 1

A positive active material and a battery cell were manufactured in substantially the same method as in Example 1 except that the first nickel-based oxide and the second nickel-based oxide were mixed after being respectively coated with cobalt rather than cobalt-coating the first nickel-based oxide and the second nickel-based oxide after mixing them in “3. Preparation of Cobalt Coating Portion and Final Positive Active Material of Example 1.”

The cobalt coating proceeded as follows. 5 parts by mole of lithium hydroxide and 2.5 parts by mole of cobalt oxide based on 100 parts by mole of transition elements were mixed with the first nickel-based oxide and then, put in a furnace and thirdly heat-treated at about 710° C. for 15 hours under an oxygen atmosphere and then, cooled down to room temperature, obtaining a first positive active material. In addition, 5 parts by mole of lithium hydroxide and 2.5 parts by mole of cobalt oxide based on 100 parts by mole of transition elements were mixed with the second nickel-based oxide and then, put in a furnace and thirdly heat-treated at about 850° C. for 15 hours under an oxygen atmosphere and then, cooled down to room temperature, obtaining a second positive active material. The cobalt-coated first positive active material and the cobalt-coated second positive active material were mixed in a weight ratio of 7:3, preparing a final positive active material according to Comparative Example 1.

### Evaluation Example 1: Analysis of Surface and Fracture Surface of Single Particles

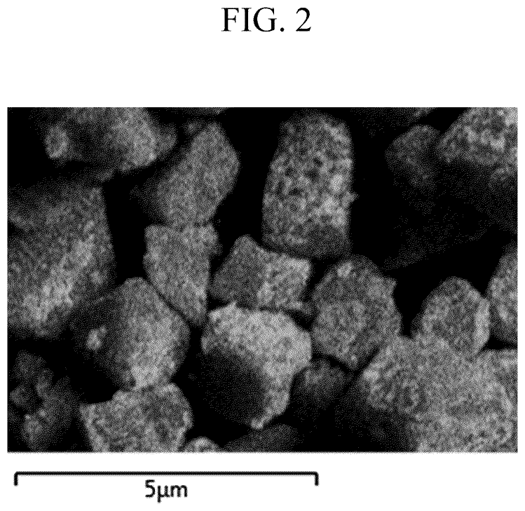

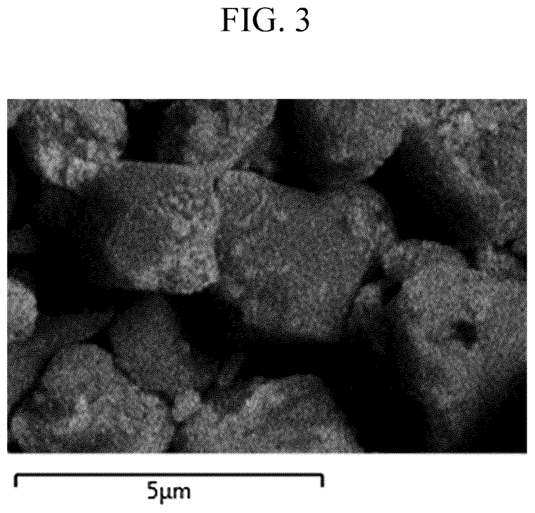

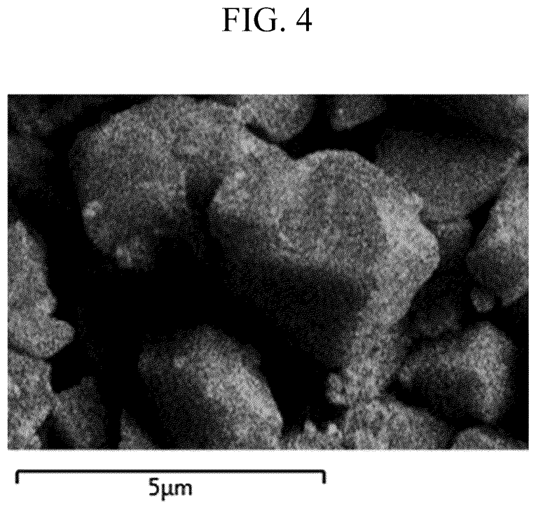

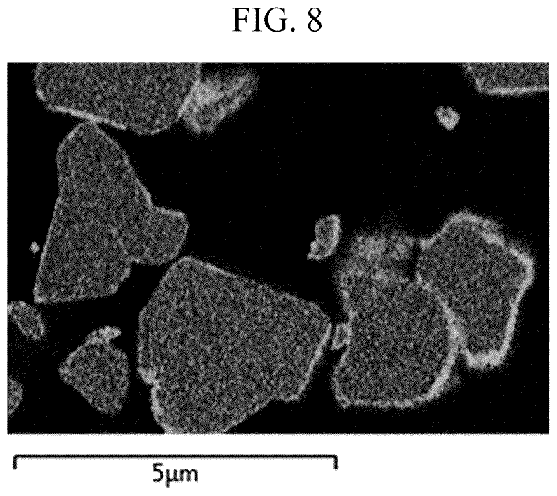

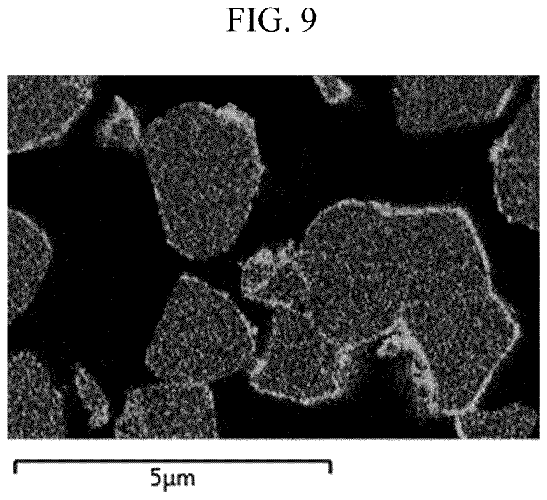

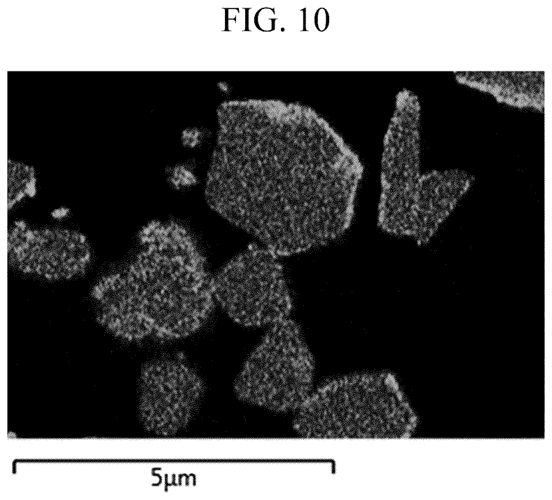

FIGS. 2 to 4 are SEM-EDS analysis images of particles corresponding to the second positive active material in the final positive active material of Example 1, in which cobalt elements are highlighted with light blue. In addition, FIGS. 8 to 10 are SEM-EDS analysis images of the fracture surface of the second positive active material of Example 1, in which similarly, the cobalt elements are highlighted with light blue.

Referring to FIGS. 2 to 4 and FIGS. 8 to 10, the cobalt elements are not uniformly dispersed on the surfaces of the single particles but distributed at a high concentration on some surfaces (e.g., some parts of the surfaces) of the single particles.

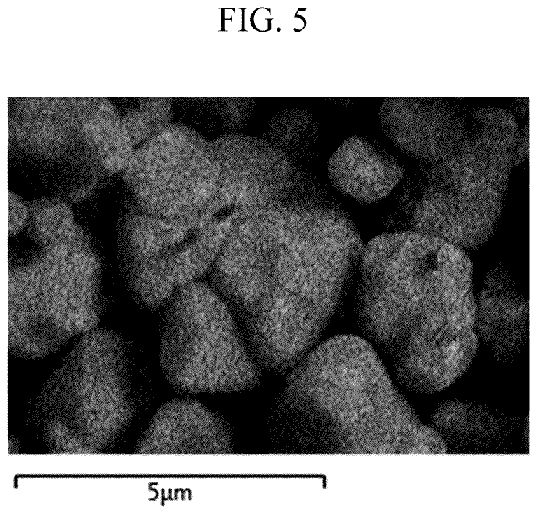

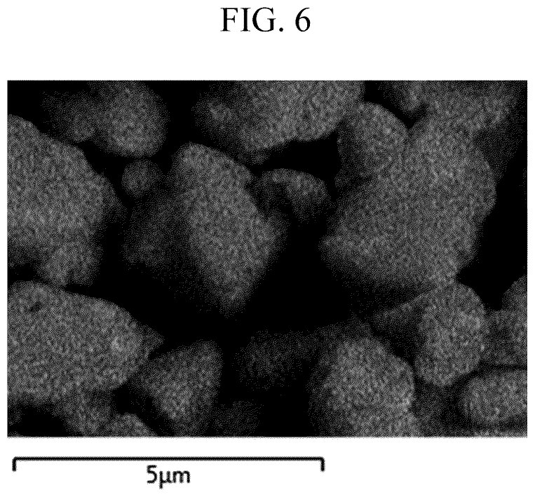

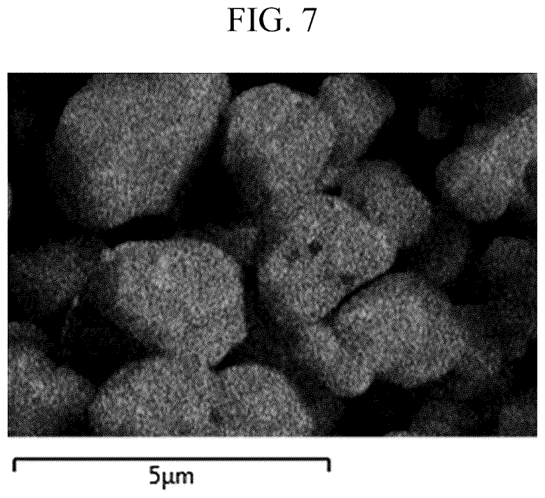

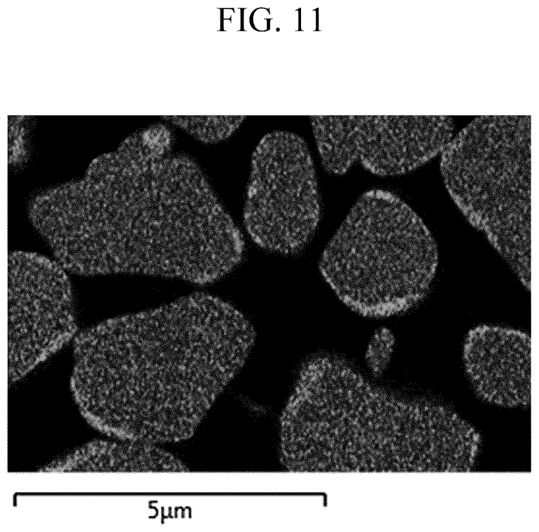

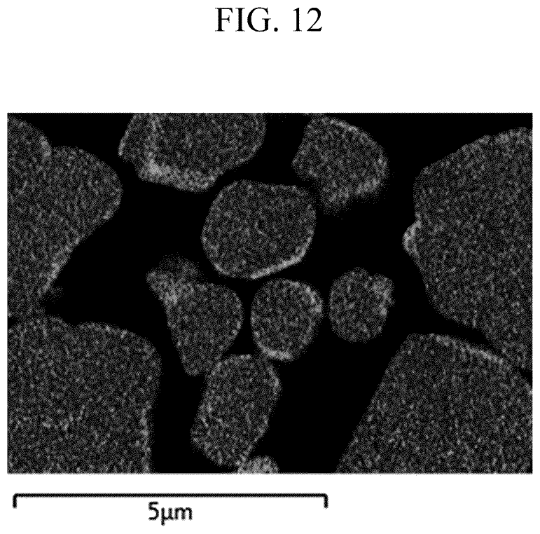

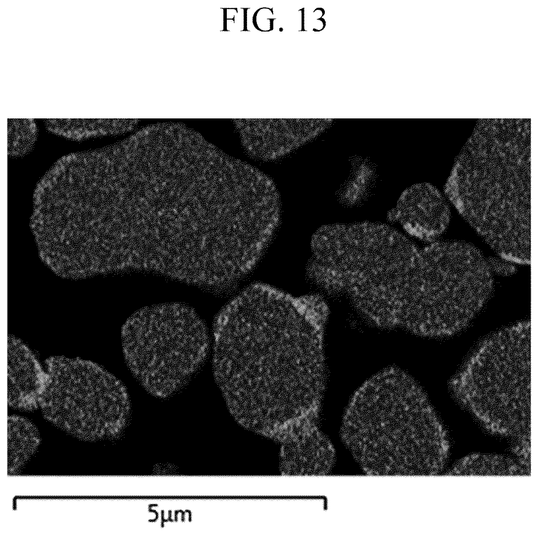

FIGS. 5 to 7 shows SEM-EDS analysis images of the second positive active material according to Comparative Example 1, in which cobalt elements are blue-highlighted with light blue. In addition, FIGS. 11 to 13 are SEM-EDS analysis images of the fracture surface of the second positive active material according to Comparative Example 1, in which similarly, cobalt elements are blue-highlighted with light blue.

Referring to FIGS. 5 to 7 and FIGS. 11 to 13, in the second positive active material of Comparative Example 1, the cobalt elements are uniformly distributed on the single particle surfaces.

### Evaluation Example 2: Analysis of Cobalt Content on the Surface of Single Particles

The second positive active materials of Example 1 and Comparative Example 1 are SEM-EDS analyzed with respect to each surface (e.g., with respect to different positions on each surface) to measure a cobalt content (e.g., amount) based on the total amount of nickel and cobalt.

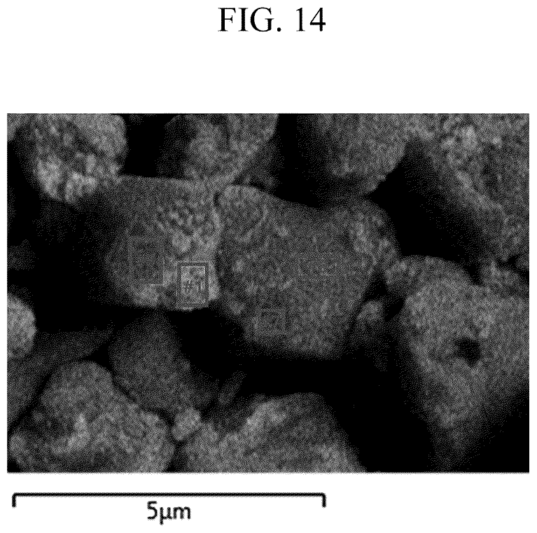

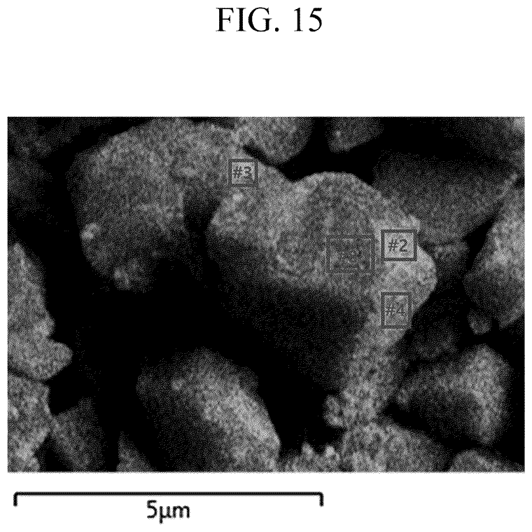

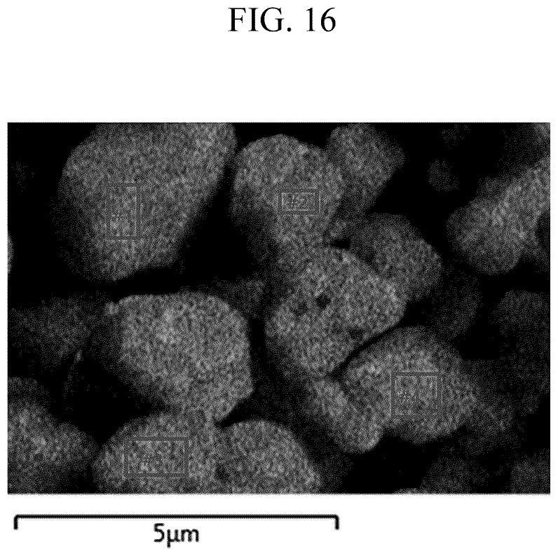

FIGS. 14 and 15 are SEM-EDS analysis images of the second positive active material of Example 1, and FIG. 16 is an SEM-EDS analysis image of the second positive active material of Comparative Example 1, wherein a cobalt content (e.g., amount) is measured at each number position, and the results are shown in Table 1.

TABLE 1

| | Position | Co/(Ni + Co) (at %) | Remarks |
|---|---|---|---|
| Example 1 | #1 | 57.8 | high-concentration |
| | #2 | 60.2 | coating region |
| | #3 | 40.7 | |
| | #4 | 52.9 | |
| | #5 | 17.5 | low-concentration |
| | #6 | 16.0 | coating region |
| | #7 | 20.4 | |
| | #8 | 19.4 | |

TABLE 2

| | Position | Co/(Ni + Co) (at %) |
|---|---|---|
| Comparative Example 1 | #1 | 8.9 |
| | #2 | 15.5 |
| | #3 | 12.0 |
| | #4 | 8.6 |

As shown in Table 1, the second positive active material of Example 1 is distinguished into a high-concentration coating region having a cobalt content (e.g., amount) of greater than or equal to 30 at % and a low-concentration coating region having a cobalt content (e.g., amount) of less than or equal to about 25 at %. The cobalt content (e.g., amount) of the high-concentration coating region has an arithmetic mean of 52.9 at %, and the cobalt content (e.g., amount) of the low-concentration coating region has an arithmetic mean of 18.3 at %, of which a difference is 34.6 at %. In contrast, as shown in Table 2, the second positive active material of Comparative Example 1 exhibits a similar cobalt content (e.g., amount) of less than or equal to 15.5 at % on all the surfaces of the single particles and thus no distinction of the high and low concentration regions.

### Evaluation Example 3: Analysis of Difference in Cobalt Content Between Surface and Inside of Single Particles

The second positive active materials of Example 1 and Comparative Example 1 are SEM-EDS analyzed on the surfaces to measure each cobalt content (e.g., amount) based on the total amount of nickel and cobalt. In addition, the second positive active materials of Example 1 and Comparative Example 1 are SEM-EDS analyzed with respect to the fracture surfaces to measure each cobalt content (e.g., amount) based on the total amount of nickel and cobalt inside the single particles. A difference of a cobalt content (e.g., amount) on the surface and a cobalt content (e.g., amount) inside the single particle is calculated, and the results are shown in Table 3. Herein, the cobalt contents on the surface and inside the single particle are an average value, wherein each cobalt content (e.g., amount) at 5 to 10 locations is measured and averaged.

TABLE 3

| | | | Difference |
|---|---|---|---|
| | Surface | Inside | between surface and inside |
| | (at %) | (at %) | (at %) |
| Example 1 | 35.61 | 6 | 29.61 |
| Comparative Example 1 | 11.25 | 6 | 5.25 |

Referring to Table 3, the second positive active material of Example 1 has a cobalt content (e.g., amount) of 35.61 at % on the surface, which is in a range of about 25 to 40 at %, but the second positive active material of Comparative Example 1 has a cobalt content (e.g., amount) of 11.25 at % on the surface, which is in a range of about 10 to 20 at %. Accordingly, there is a large difference in the cobalt contents coated on the surface of the second positive active materials according to a coating method. In addition, comparing a difference of the cobalt contents on the single particle surface and inside the single particle, Example 1 exhibits 29.61 at %, while Comparative Example 1 exhibits 5.25 at %. Example 1 exhibits a larger difference in the cobalt contents on the single particle surface and inside the single particle than Comparative Example 1. The second positive active material exhibiting these characteristics increases efficiency as well as realizes high-capacity.

### Evaluation Example 4: Charging/Discharging Efficiency and Life Cycle Characteristics

Each coin half-cell of Example 1 and Comparative Example 2 is charged at a constant current (0.2 C) and a constant voltage (4.25 V, cut-off at 0.05 C) and then, measured with respect to charge capacity, paused for 10 minutes, and discharged to 3.0 V at a constant current (0.2 C) and then, measured with respect to discharge capacity. A ratio the discharge capacity relative to the charge capacity is expressed as efficiency. The results are shown in Table 4.

In addition, the cells are initially charged and discharged and then, 50 times charged and discharged at 1 C at 45° C. to measure the 50^{th} discharge capacity, and a ratio (%) of the 50^{th} discharge capacity relative to the initial discharge capacity is expressed as capacity retention, that is, life cycle characteristics in Table 4.

TABLE 4

| | Charge | Discharge | | 50 cycle capacity |
|---|---|---|---|---|
| | capacity | capacity | Efficiency | retention |
| | (mAh/g) | (mAh/g) | (%) | (%, 45° C.) |
| Example 1 | 237.9 | 209.4 | 88.0 | 97.1 |
| Comparative | 237.0 | 208.3 | 87.9 | 93.8 |
| Example 1 | | | | |

Referring to Table 4, Example 1, compared with Comparative Example 1, exhibits increased discharge capacity and improved charge and discharge efficiency and in addition, improved high temperature life cycle characteristics.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

Reference Numerals

| | |
|---|---|
| 100: rechargeable lithium battery | 112: negative electrode |
| 113: separator | 114: positive electrode |
| 120: battery case | 140: sealing member |

What is claimed is:

1. A positive active material for a rechargeable lithium battery, the positive active material comprising:
a first positive active material comprising a lithium nickel-based composite oxide and comprising secondary particles in which a plurality of primary particles are aggregated and a cobalt coating portion on a secondary particle surface of each of the secondary particles, and
a second positive active material comprising a lithium nickel-based composite oxide and comprising single particles and a cobalt coating portion on a single particle surface of each of the single particles,
wherein the single particle surface comprises a high-concentration coating region having a cobalt content of greater than or equal to about 30 at % and a low-concentration coating region having a cobalt content of less than or equal to about 25 at % based on the total amount of nickel and cobalt on the single particle surface, and
a difference between the cobalt content in the high-concentration coating region and the cobalt content in the low-concentration coating region is about 20 at % to about 50 at %.

2. The positive active material of claim 1, wherein an average cobalt content inside each of the single particles of the second positive active material is about 0 at % to about 15 at % based on the total amount of nickel and cobalt in the lithium nickel-based composite.

3. The positive active material of claim 1, wherein an average cobalt content on the surfaces of the single particles of the second positive active material is about 20 at % to about 60 at % based on the total amount of nickel and cobalt in the lithium nickel-based composite.

4. The positive active material of claim 1, wherein
a difference between the average cobalt content on the surfaces of the single particles and the cobalt content in the single particles is about 10 at % to about 60 at % based on the total amount of nickel and cobalt in the lithium nickel-based composite.

5. The positive active material of claim 1, wherein
the lithium nickel-based composite oxide of the second positive active material is represented by Chemical Formula 11:
Liₐ₁₁Niₓ₁₁Co_{y11}M¹¹_{1-x11-y11}O₂, Chemical Formula 11
wherein, in Chemical Formula 11, 0.9≤a11≤1.8, 0.6≤x11≤1, and 0≤y11≤0.15, and M¹¹ is at least one element selected from Al, B, Ba, Ca, Ce, Cr, Cu, F, Fe, Mg, Mn, Mo, Nb, P, S, Si, Sr, Ti, V, W, and Zr.

6. The positive active material of claim 5, wherein
in Chemical Formula 11, 0.9≤x11≤1, and 0≤y11≤0.1.

7. The positive active material of claim 1, wherein
an average particle size of the secondary particles of the first positive active material is about 7 μm to about 25 μm, and
an average particle size of the single particles of the second positive active material is about 1 μm to about 7 μm.

8. The positive active material of claim 1, wherein
the first positive active material is in an amount of about 50 wt % to about 90 wt % and the second positive active material is in an amount of about 10 wt % to about 50 wt % based on the total amount of the first positive active material and the second positive active material.

9. The positive active material of claim 1, wherein
the lithium nickel-based composite oxide of the first positive active material is represented by Chemical Formula 1:
Liₐ₁Niₓ₁M¹_{y1}M²_{1-x1-y1}O₂, Chemical Formula 1
and
wherein, in Chemical Formula 1, 0.9≤a1≤1.8, 0.3≤x1≤1, 0≤y1≤0.7, and M¹ and M² are each independently at least one element selected from Al, B, Ba, Ca, Ce, Co, Cr, Cu, F, Fe, Mg, Mn, Mo, Nb, P, S, Si, Sr, Ti, V, W, and Zr.

10. A method of preparing a positive active material for a rechargeable lithium battery, the method comprising:
mixing a first nickel-based hydroxide and a lithium raw material and performing first heat-treatment to prepare a first nickel-based oxide in a form of secondary particles in which a plurality of primary particles are aggregated;
mixing a second nickel-based hydroxide and a lithium raw material and performing a second heat treatment to prepare a second nickel-based oxide in a form of the single particles; and
mixing the first nickel-based oxide, the second nickel-based oxide, and a cobalt raw material and performing a third heat treatment to obtain the positive active material of claim 1.

11. The method of claim 10, wherein
the first nickel-based hydroxide is represented by Chemical Formula 21, and
the second nickel-based hydroxide is represented by Chemical Formula 31:
Niₓ₂₁M²¹_{y21}M²²_{1-x21-y21}(OH)₂, Chemical Formula 21
wherein, in Chemical Formula 21, 0.3≤x21≤1, 0≤y21≤0.7, and M²¹ and M²² are each independently at least one element selected from Al, B, Ba, Ca, Ce, Co, Cr, Cu, F, Fe, Mg, Mn, Mo, Nb, P, S, Si, Sr, Ti, V, W, and Zr,
Niₓ₃₁CO_{y31}M³¹_{1-x31-y31}(OH)₂, Chemical Formula 31
and
wherein, in Chemical Formula 31, 0.6≤x31≤1, and 0≤y31≤0.15, and M³¹ is at least one element selected from Al, B, Ba, Ca, Ce, Cr, Cu, F, Fe, Mg, Mn, Mo, Nb, P, S, Si, Sr, Ti, V, W, and Zr.

12. The method of claim 10, wherein
the first heat-treatment is performed at a temperature range of about 600° C. to about 900° C. for about 5 hours to about 20 hours.

13. The method of claim 10, wherein
the second heat-treatment is performed at a temperature range of about 800° C. to about 1100° C. for about 5 hours to about 20 hours.

14. The method of claim 10, further comprising:
pulverizing a product obtained by the second heat treatment to obtain the second nickel-based oxide in a form of the single particles.

15. The method of claim 10, wherein
in the mixing of the first nickel-based oxide, the second nickel-based oxide, and a cobalt raw material, the first nickel-based oxide and the second nickel-based oxide are mixed in a weight ratio of about 9:1 to about 5:5.

16. The method of claim 10, wherein
in the mixing of the first nickel-based oxide, the second nickel-based oxide, and the cobalt raw material, a total content of metals other than lithium in the first nickel-based oxide and the second nickel-based oxide is 100 parts by mole, and the cobalt contained in the cobalt raw material is about 0.01 parts by mole to about 7 parts by mole.

17. The method of claim 10, wherein
in the mixing of the first nickel-based oxide, the second nickel-based oxide, and the cobalt raw material, the lithium raw material is mixed together.

18. The method of claim 17, wherein
the lithium raw material is mixed in an amount of 1 part by mole to 4 parts by mole based on 1 part by mole of the cobalt raw material.

19. The method of claim 10, wherein
the third heat treatment is performed at a temperature range of 650° C. to 900° C. for about 5 hours to about 30 hours.

20. A rechargeable lithium battery comprising a positive electrode comprising the positive active material of claim 1, a negative electrode, and an electrolyte.
